(19) United States
(12) Patent Application Publication
(10) Pub. No.: US 2023/0361894 A1
(43) Pub. Date: Nov. 9, 2023

(54) CHANNEL-SENSING MEASUREMENT AND CHANNEL ACCESS REPORT

(71) Applicant: Lenovo (Singapore) Pte. Ltd., New Tech Park (SG)

(72) Inventors: Ankit Bhamri, Rödermark (DE); Karthikeyan Ganesan, Kronberg im Taunus (DE); Alexander Johann Maria Golitschek Edler von Elbwart, Darmstadt (DE); Ali Ramadan Ali, Kraiburg am Inn (DE); Vijay Nangia, Woodridge, IL (US)

(21) Appl. No.: 18/245,310

(22) PCT Filed: Sep. 14, 2021
(86) PCT No.: PCT/IB2021/058381

§ 371 Date: Mar. 14, 2023

Related U.S. Application Data
(60) Provisional application No. 63/078,294, filed on Sep. 14, 2020.

(51) Int. Cl. H04B 17/345; H04B 17/318; H04W 24/10

(52) U.S. Cl. CPC H04B 17/345; H04B 17/318; H04W 24/10

(57) ABSTRACT

Apparatuses, methods, and systems are disclosed for measuring and reporting channel access statistics. One apparatus includes a processor and a transceiver that receives a configuration message from a network, said configuration message indicating a measurement resource for channel sensing and a spatial beam for the measurement resource. Here, the apparatus does not transmit on the measurement resource and the network also does not transmit on the measurement resource. The processor performs channel-sensing measurement using the indicated measurement resource and spatial beam and generates a channel access report using a plurality of channel-sensing measurements. The transceiver sends the channel access report to the network.

### CROSS-REFERENCE TO RELATED APPLICATIONS

This application claims priority to U.S. Provisional Patent Application No. 63/078,294 entitled “REFERENCE SIGNAL AND REPORTING FOR LONG-TERM SENSING FOR UNLICENSED CHANNEL ACCESS” and filed on Sep. 14, 2021 for Ankit Bhamri, Karthikeyan Ganesan, Alexander Johann Maria Golitschek Edler von Elbwart, Ali Ramadan Ali, and Vijay Nangia, which application is incorporated herein by reference.

### FIELD

The subject matter disclosed herein relates generally to wireless communications and more particularly relates to configuring measurements and reporting for long-term sensing of channel access, for example in unlicensed/shared spectrum.

### BACKGROUND

For operation in unlicensed spectrum (also referred to as shared spectrum) because a channel may be shared among various, unrelated users it is possible that a particular user (i.e., a User Equipment (“UE”)) may experience inter-network interference and/or inter-system interference.

### BRIEF SUMMARY

Disclosed are procedures for measuring and reporting inter-system interference and/or channel availability in specific beam directions. Said procedures may be implemented by apparatus, systems, methods, or computer program products.

One method of a User Equipment (“UE”) for measuring and reporting channel access statistics includes receiving a configuration message from a network, said configuration message indicating a measurement resource for channel sensing and a spatial beam for the measurement resource. Here, the UE does not transmit on the measurement resource and the network also does not transmit on the measurement resource. The method includes performing channel-sensing measurement using the indicated measurement resource and spatial beam. The method includes generating a channel access report using a plurality of channel-sensing measurements and sending the channel access report to the network.

One method of a Radio Access Network (“RAN”) entity in a network includes selecting a measurement resource for channel sensing and a spatial beam for the measurement resource and transmitting a configuration message to a UE, said configuration message indicating the selected measurement resource for channel sensing and the selected spatial beam. Here, the UE does not transmit on the measurement resource and the network also does not transmit on the measurement resource. The method includes receiving a channel access report from the UE, said channel access report including channel access statistics generated using a plurality of channel-sensing measurements performed on the selected measurement resource and spatial beam.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for measuring and reporting channel access statistics;

FIG. 2 is a call-flow diagram illustrating one embodiment of configuring measurements and reporting for long-term sensing of channel access;

FIG. 3 is a diagram illustrating one embodiment of combined sensing from multiple UEs in a close vicinity;

FIG. 4 is a block diagram illustrating one embodiment of a Fifth-Generation (“5G”) New Radio (“NR”) protocol stack;

FIG. 5 is a block diagram illustrating one embodiment of a user equipment apparatus that may be used for measuring and reporting channel access statistics;

FIG. 6 is a block diagram illustrating one embodiment of a network apparatus that may be used for measuring and reporting channel access statistics;

FIG. 7 is a flowchart diagram illustrating one embodiment of a first method for measuring and reporting channel access statistics; and

FIG. 8 is a flowchart diagram illustrating one embodiment of a second method for measuring and reporting channel access statistics.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for measuring and reporting channel access statistics. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Currently for sub-6 GHz New Radio (“NR”) operation on unlicensed spectrum (referred to as “NR-U”), only short-term channel sensing in the form of omni-directional Listen-Before Talk (“LBT”) is supported. However, in the on-going study on beyond 52.6 GHz (i.e., “B52.6 GHz”), unlicensed channel access at 60 GHz is being discussed and it has been agreed that both LBT and no-LBT based unlicensed channel access mechanism will be supported in NR Rel-17. Moreover, directional (beam-based) channel access is also considered that would require sensing channels in different beam directions. The main purpose of channel sensing is two-fold, i.e., to protect the on-going transmissions from being interfered by the intended transmission and protect the intended transmission from being interfered by the on-going transmission.

Therefore, long-term sensing is important for unlicensed access. This disclosure provides solutions on how to facilitate long-term sensing at the UE to identify potential interference from other systems such as Wi-Fi/WiGig and allow network to access channel and beams accordingly for fair coexistence with those other systems.

As mobile communication networks operate in frequency ranges above 52.6 GHz, changes are required to adapt NR waveform and radio access technologies to support operation at the higher frequencies (e.g., between 52.6 GHz and 71 GHz). Further, operation on shared (i.e., unlicensed) spectrum channel sensing is required and there is potential interference with other nodes also operating on the same shared spectrum band(s).

In particular, a study item for 3GPP NR is to evaluate the channel access mechanism in frequency ranges above 52.6 GHz, considering potential interference to/from other nodes, assuming beam-based operation, in order to comply with the regulatory requirements applicable to unlicensed spectrum for frequencies between 52.6 GHz and 71 GHz. Regarding physical layer procedures, the channel access mechanism may assume beam-based operation for frequency ranges above 52.6 GHz, in order to comply with regulatory requirements applicable to unlicensed spectrum for frequencies between 52.6 GHz and 71 GHz.

For a gNB (i.e., 5th generation base station) and/or UE to initiate a channel occupancy, both channel access with LBT mechanism(s) and a channel access mechanism without LBT are supported. When channel access with LBT is used, the LBT mechanisms may include: Omni-directional LBT, directional LBT and receiver-assisted LBT type of schemes. In certain embodiments, operation restrictions for channel access without LBT are needed, e.g., compliance with regulations, and/or in presence of Automatic Transmit Power Control (“ATPC”), Dynamic Frequency Selection (“DFS”), long-term sensing, or other interference mitigation mechanisms. Various mechanism and condition(s) to switch between channel access with LBT and channel access without LBT (if local regulation allows) may be defined.

It is agreed to use the LBT procedures as the baseline system evaluation with LBT. In certain embodiments, the Energy Detection (“ED”) threshold, contention window size (“CWS”), etc. can be enhanced for frequency ranges above 52.6 GHz, as compared to frequency ranges below 6 GHz. Regarding the state-of-art co-existence mechanisms for unlicensed channel access in 60 GHz, in addition to LBT, two no-LBT based inter-system co-existence schemes are being discussed for the 60 GHz unlicensed band: Dynamic Frequency Selection and Automatic Transmit Power Control.

Regarding Dynamic Frequency Selection (“DFS”), modern Multiple Gigabit Wireless Systems (“MGWS”) use wideband silicon implementations comprising power amplifiers (“Pas”), low-noise amplifiers (“LNAs”) and tunable local oscillators (“Los”) with bandwidths of ten to several tens of GHz. The current WiGig systems, for example, are designed to operate in all four IEEE 802.11ad channels (57-66 GHz), and the next generation of WiGig systems developed under IEEE 802.11ay are expected to support two additional channels reaching out to 71 GHz. Wideband silicon designs enable MGWS to operate in a large number of channels in the 60 GHz band, dynamically switching the channel of operation to avoid frequency overlapping with a channel occupied by applications in other services, including Frequency Selection (“FS”).

Automatic Transmit Power Control (“ATPC”) is an important mechanism built into MGWS implementations to minimize intra-system interference (also known as “self-interference”). A transmitter adjusts its transmit power based on feedback from receiver to the minimum necessary to operate a link with desired performance. A typical MGWS using IEEE 802.11ad technology, for example, can reduce the transmit power by an average of 1 dBm for every 10-meter reduction in link distance from 200 to 50 meters. Protocol-level mechanisms to adjust transmit power through closed-loop feedback are easy to implement and work well in despite of imperfect knowledge of antenna gain and other signal transition losses and measurement imperfections.

ATPC is beneficial to MGWS operation alone, and to MGWS and FS coexistence. It should be considered as one of the most effective dynamic methods for spectrum sharing. In conjunction with DFS and in realistic cases, improvement of many times or full resolution of interference, leading to throughput increase, have been simulated or measured. As a consequence, the adoption of such mechanism(s) is deemed very effective to reduce interference scenarios in all use cases.

Disclosed are procedures for measuring and reporting inter-system interference or channel availability in specific beam directions. In order to support long-term sensing for unlicensed channel access, new RRC signaling (both UE-specific and UE-common signaling) is described to enable the configuration of resources, periods, beam directions for facilitating sensing from other networks and other systems such as Wi-Fi/WiGig. A UE may report different measurements for long-term sensing, both for LBT and no-LBT based channel access mechanism in unlicensed bands.

The disclosed solutions include receiver assistance (i.e., from the UE) to aid the gNB with direction LBT or not-LBT modes. For the purpose of receiver assistance, reporting the long-term channel sensing statistics may include reporting based on Layer-1 (“L1”) Received Signal Strength Indicator (“RSSI”). In one embodiment, the RSSI measurement is based on the time/frequency resources configured for Zero-Power (“ZP”) Channel State Information (“CSI”) Reference Signal (“RS”), referred to as “ZP-CSI-RS.” For example, the ZP-CSI-RS may be enhanced to comprise ZP-CSI-RS over all Resource Elements (“REs”) in a bandwidth part (“BWP”) over one or more symbols. In another embodiment, the RSSI measurement may be based on energy measurement on an operating bandwidth over an indicated or specified number of symbols or time interval.

In certain embodiments, the Layer-1 RSSI (“L1-RSSI”) is reported in an aperiodic channel state information (“AP-CSI”) report. In certain embodiments, the UE receives a L1-RSSI trigger in an uplink (“UL”) grant. In one embodiment, a L1-RSSI trigger can also be carried in DL grant. In some embodiments, the timeline for L1-RSSI reporting is at least equal to aperiodic channel state information (“AP-CSI”) reporting. In certain embodiments, the UE may be configured with a measurement beam for L1-RSSI. In certain embodiment, the L1-RSSI report may include the value of RSSI measurement, comparison outcome with Energy Detection (“ED”) threshold, etc.

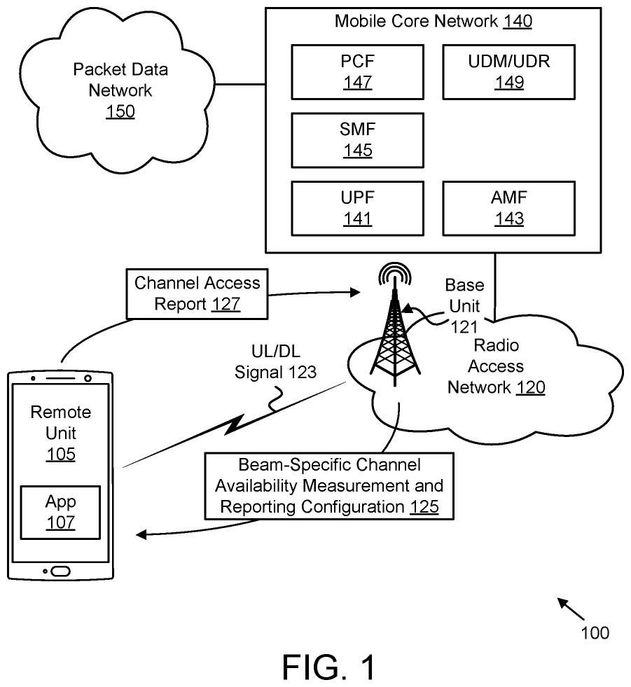

FIG. 1 depicts a wireless communication system 100 for measuring and reporting channel access statistics, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM””) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for measuring and reporting channel access statistics apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In various embodiments, the remote unit 105 receives a configuration 125 for measuring and reporting channel availability in specific beam directions. As described in greater detail below, the configuration 125 indicates a set of one or more measurement resources to use and a corresponding beam direction for each measurement resource. Note that while the configuration 125 is activated, the wireless communication network does not use the indicated measurement resource(s), thereby allowing the remote unit 105 to measure inter-network interference (i.e., interference due to activity on the measurement resource(s) by a different mobile communication network, such as a different NR network) and inter-system interference (i.e., interference due to another type of system, such as Wi-Fi, WiGig, etc.). In various embodiments, the configuration 125 may also indicate a set or one or more measurements to perform, a set of one or more reporting conditions (i.e., triggers), a report format, a reporting resource, and/or deactivation behavior, including how the remote unit 105 is to respond to the situation where resource allocation is later received that conflicts with a configured measurement resource.

The remote unit 105 performs measurements according to the received configuration 125 and sends a channel access report 127, according to the received configuration 125. Here, the channel access report 127 is based on a plurality of measurements. In certain embodiments, the channel access report 127 indicates how often a detected amount of energy exceeds a configured threshold, long-term average interference levels (i.e., from the last M periods for measurement resources), short-term interference values (i.e., for each of the last N periods for measurement resources, where N<M), a rate of LBT failure (or LBT success) and/or a probability of LBT failure (or LBT success).

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for measuring and reporting channel access statistics.

In some of the embodiments described, an antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

Two antenna ports may be quasi-located with respect to a subset of the large-scale to properties and different subset of large-scale properties may be indicated by a Quasi-Co-Location (“QCL”) Type. For example, the parameter ‘qcl-Type’ may take one of the following values:
‘QCL Type-A’: {Doppler shift, Doppler spread, average delay, delay spread}
‘QCL Type-B’: {Doppler shift, Doppler spread}
‘QCL Type-C’: {Doppler shift, average delay}
‘QCL Type-D’: {Spatial Rx parameter}.

Spatial Rx parameters may include one or more of: Angle of Arrival (“AoA”), Dominant AoA, average AoA, angular spread, Power Angular Spectrum (“PAS”) of AoA, average Angle of Departure (“AoD”), PAS of AoD, transmit/receive channel correlation, transmit/receive beamforming, spatial channel correlation etc.

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (“CDD”). The procedure used to derive antenna ports from physical antennas may be specific to a device implementation and transparent to other devices.

In some of the embodiments described, a TCI-state associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to QCL type parameter(s) indicated in the corresponding TCI state. A device can receive a configuration of a plurality of transmission configuration indicator states for a serving cell for transmissions on the serving cell.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter/beam used for reception the reference RS (e.g., DL RS such as SSB/CSI-RS). In another example, the device may transmit the target transmission with the same spatial domain transmission filter/beam used for the transmission of the reference RS (e.g., UL RS such as SRS). A device can receive a configuration of a plurality of spatial relation information configurations for a serving cell for transmissions on the serving cell.

Throughout the different embodiments of the disclosure, the term quasi co-location—and quasi co-located—is to be understood mainly in the terms of transmit/receive beamforming and spatial channel correlation, but should not be limited thereto.

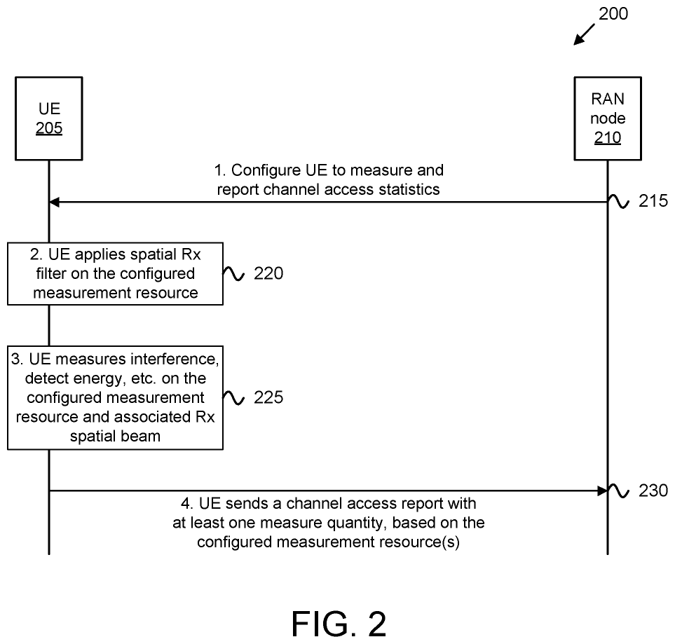

FIG. 2 depicts a first procedure 200 for measuring and reporting channel access statistics, according to embodiments of the disclosure. The first procedure involves a UE 205 and a RAN node 210, such as a gNB. The UE 205 may be one embodiment of the remote unit 105, while the RAN node 210 may be one embodiment of the base unit 121.

At Step 1, the RAN node 210 configures the UE to measure and report channel access statistics (see messaging 215). Here, the network (via RAN node 210) configures at least one resource (time-frequency resource grid) to the UE 205 and also configure at least one associated QCL assumption Type-D or one TCI state.

At Step 2, upon receiving such configuration, the UE 205 applies spatial Receive (“Rx”) filter on the configured measurement resource (see block 220). Here, the UE 205 applies the spatial Rx filter according to the indicated QCL assumption Type-D or TCI state on the configured resource and is not expected to receive/transmit any channels and signals from any node (including gNBs/TRPs/Other UEs) within the same network.

At Step 3, the UE 205 measures interference, detect energy, etc. on the configured measurement resource and associated Rx spatial beam (see block 225). Here, the UE 205 is expected to measure interference, detect energy, etc. on the configured resource and associated Rx spatial beam from the same systems (e.g., from other NR networks) or from other systems such as Wi-Fi/WiGig.

At Step 4, the UE 205 sends to the RAN node 210 a channel access report with at least one measure quantity, based on the configured measurement resource(s) (see messaging 230). In some embodiments, the channel access report includes long-term channel availability statistics. In certain embodiments, the channel access report includes short-term and/or instantaneous channel availability statistics. The network may use the channel access reports to determine both short-term and long-term availability of sensing beams based on measurements from other systems such as Wi-Fi/WLAN.

One benefit is to allow the UE 205 to measure interference and/or other channel characteristics from other systems outside of NR and/or other networks and without the need to transmit any signals and channels from any nodes within the same system. Long-term sensing is facilitated and is applicable to both LBT and no-LBT based channel access system. Fair co-existence with other systems or other networks can be better ensured.

In some of the embodiments described, the Quasi-Co-Location (“QCL”) assumption Type-D or Transmission Configuration Indicator (“TCI”) state of a measurement resource may be an active TCI state for Physical Downlink Control Channel (“PDCCH”) reception (e.g., the Reference Signal (“RS”) with QCL Type-D in the active TCI state) in one or more Control Resource Sets (“CORESETs”) with associated search space sets configured to (e.g., assigned to) the UE 205. Here, the measurement is based on beams associated with the CORESETs configured to the UE 205.

In some examples, there may be multiple QCL assumption Type-D or multiple TCI states corresponding to multiple measurement resources. In some examples a subset of configured CORESETs may be each configured with a measurement resource with for, e.g., the CORESET index(s) may be indicated to the UE 205, M measurement resources and M CORESETs associated with the search space sets in an order from the, e.g., shortest monitoring periodicity, and in case of more than one CORESETs associated with search space sets having same monitoring periodicity, the UE determines the order of the CORESET from the highest CORESET index.

In some examples, the measurement resource periodicity may be configured or determined from the search space monitoring periodicity, or max(search space periodicity, x ms) with, e.g., x=2, or x=5. In some examples, the measurement resource configuration may be part of the CORESET configuration. In some examples, the measurement resource may be on one or more symbols of the CORESET. The measurement resource may be a Control Channel Element (“CCE”) which may be indicated to the UE by a CCE index, may be a Resource Element group (“REG”) or REG bundle which may be indicated by a REG/REG bundle index; and may exclude the Demodulation Reference Signal (“DMRS”) Resource Elements (“REs”). Note that the REs in the CORESET are organized into REGs, where each REG consists of 1 Resource Block (“RB”), i.e., 12 REs of 1 Orthogonal Frequency Division Multiplexing (“OFDM”) symbol. Note that one CCE consists of multiple REGs.

In some of the embodiments described below, the measurement indication (e.g., interference level, LBT failure) may be delivered to higher layers, e.g., once per indication period. In some examples, the UE assesses once per indication period the interference level and/or LBT failure statistics evaluated over the previous time period. The indication period may be the period a multiple of the shortest periodicity for measurement resources, or maximum between the shortest periodicity for measurement resources and x ms (e.g., x=5, or x=10). Here the statistics in terms of either interference level or expected LBT success/failure are determined. Interference statistics from other systems are applicable for both LBT based and no-LBT based mechanism. On the other hand, LBT success/failure statistics applicable to mainly LBT based mechanism.

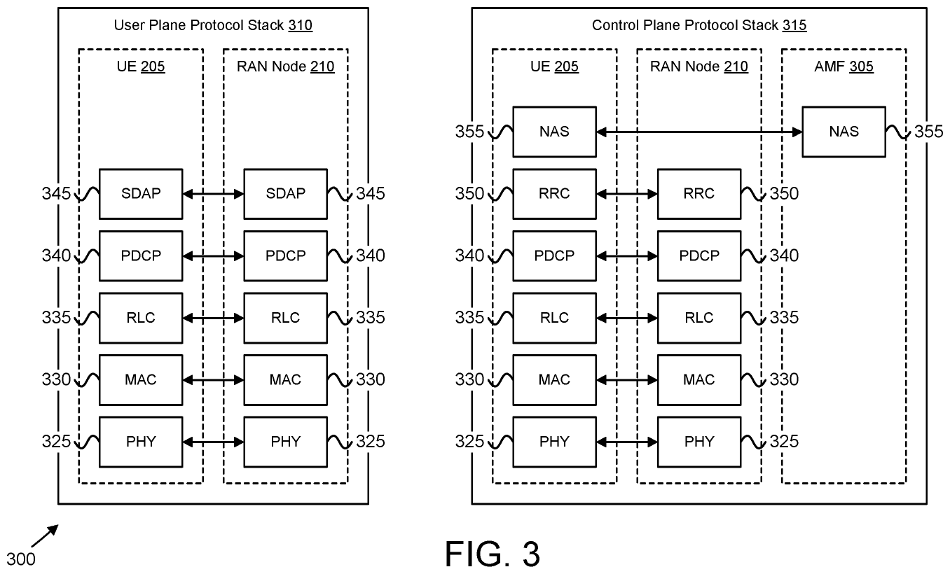

FIG. 3 depicts a NR protocol stack 300, according to embodiments of the disclosure. While FIG. 3 shows the UE 205, the RAN node 210 and an AMF 305 in a 5G core network (“5GC”), these are representative of a set of remote units 105 interacting with a base unit 121 and a mobile core network 140. As depicted, the protocol stack 300 comprises a User Plane protocol stack 310 and a Control Plane protocol stack 315. The User Plane protocol stack 310 includes a physical (“PHY”) layer 325, a Medium Access Control (“MAC”) sublayer 330, the Radio Link Control (“RLC”) sublayer 335, a Packet Data Convergence Protocol (“PDCP”) sublayer 340, and Service Data Adaptation Protocol (“SDAP”) layer 345. The Control Plane protocol stack 315 includes a physical layer 325, a MAC sublayer 330, a RLC sublayer 335, and a PDCP sublayer 340. The Control Plane protocol stack 315 also includes a Radio Resource Control (“RRC”) layer 350 and a Non-Access Stratum (“NAS”) layer 355.

The AS layer (also referred to as “AS protocol stack”) for the User Plane protocol stack 310 consists of at least SDAP, PDCP, RLC and MAC sublayers, and the physical layer. The AS layer for the Control Plane protocol stack 315 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 350 and the NAS layer 355 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 325 offers transport channels to the MAC sublayer 330. The physical layer 325 may perform a Clear Channel Assessment and/or Listen-Before-Talk (“CCA/LBT”) procedure using energy detection thresholds, as described herein. In certain embodiments, the physical layer 325 may send a notification of UL Listen-Before-Talk (“LBT”) failure to a MAC entity at the MAC sublayer 330. The MAC sublayer 330 offers logical channels to the RLC sublayer 335. The RLC sublayer 335 offers RLC channels to the PDCP sublayer 340. The PDCP sublayer 340 offers radio bearers to the SDAP sublayer 345 and/or RRC layer 350. The SDAP sublayer 345 offers QoS flows to the core network (e.g., 5GC). The RRC layer 350 provides for the addition, modification, and release of Carrier Aggregation and/or Dual Connectivity. The RRC layer 350 also manages the establishment, configuration, maintenance, and release of Signaling Radio Bearers (“SRBs”) and Data Radio Bearers (“DRBs”).

The NAS layer 355 is between the UE 205 and the 5GC (i.e., AMF 305). NAS messages are passed transparently through the RAN. The NAS layer 355 is used to manage the establishment of communication sessions and for maintaining continuous communications with the UE 205 as it moves between different cells of the RAN. In contrast, the AS layer is between the UE 205 and the RAN (i.e., RAN node 210) and carries information over the wireless portion of the network.

According to embodiments of the first solution, the UE 205 may be configured by the network (i.e., by the RAN node 210) with measurement resources at regular intervals of time and QCL assumption Type-D or TCI state, where the UE 205 is not expected to receive/transmit any channels and signals from any node (including gNBs/TRPs/Other UEs) within the same network. In this solution, the UE is configured with resources to measure inter-system interference primarily by ensuring that UE is not expected to be configured/scheduled with any channels/signals within the same network. Specifically, the UE 205 does not use the measurement resources (i.e., does not transmit signals on the measurement resources and is not expected to receive signals on the measurement resources). Additionally, the network does not use the measurement resources (i.e., does not transmit signals on the measurement resources and is not expected to receive signals on the measurement resources).

In one implementation of this first solution, the UE 205 is semi-statically configured by the RAN node 210 via UE-specific RRC signaling with one or more periodic resources in terms of at least one or more of the following parameters, including: periodicity, time offset, QCL assumption Type-D, time symbols, frequency resources, measurement quantities, reporting resources. Once the UE 205 receives the RRC configuration, the UE 205 is expected to perform measurements as long as the UE 205 is not configured with release or deactivation of the periodic configured measurement resources, e.g., either semi-statically by RRC or dynamic signaling via MAC Control Element (“CE”) or Downlink Control Information (“DCI”). In one example, the QCL assumption Type-D is indicated dynamically via MAC CE or DCI.

In another implementation of this first solution, periodic Zero-Power Channel State Information Reference Signal (“ZP-CSI-RS”) or Channel State Information-Interference Measurement (“CSI-IM”) could be alternatively configured for inter-system interference measurements where the UE 205 is not expected to receive/transmit any signals and channels from any nodes within the network in the specific Rx beam direction at the UE 205 on the configured measurement resources.

In another embodiment of this first solution, the UE 205 may be semi-statically configured by the RAN node 210 via UE-specific RRC signaling with one or more semi-persistent measurement resources in terms of at least one or more of the following parameters, including: periodicity, time offset, QCL assumption Type-D, time symbols, frequency resources, measurement quantities, reporting resources. Once the UE 205 receives the UE-specific RRC configuration and receives activation via MAC CE or DCI, then only the signaled UE 205 is expected to perform measurements. The UE 205 will stop measurements once the UE 205 is indicated semi-statically by RRC or dynamic signaling via MAC CE or DCI to deactivate the semi-persistent configured measurement resources. In one example, the QCL assumption Type-D is indicated dynamically via MAC CE or DCI. In the above embodiments, the UE 205 may be configured with measurement resources over the entire frequency/bandwidth. In certain embodiments, the UE 205 may be configured with one or more bandwidth parts (“BWPs”). Here, the UE 205 may be configured with measurement resources over the entire configured BWP (e.g., an active configured BWP). Alternatively, the UE may be configured with one or more measurement resources on an inactive configured BWP to reduce intra-network interference or self-interference.

In an alternate embodiment of this first solution, the network transmits a common configuration to a group of UEs for measurement resource configuration. Here, the UE 205 may be semi-statically configured by the RAN node 210 via common RRC signaling with one or more periodic measurement resources in terms of at least one or more of the following parameters including periodicity, time offset, QCL assumption Type-D, time symbols, frequency resources, measurement quantities. In this embodiment, all the UEs 205 that receive the common RRC configuration are expected to perform measurements as long as the UE is not configured with release or deactivation of the periodic configured measurement resources, e.g., either semi-statically by RRC or dynamic signaling via MAC CE or group-common DCI.

In one example, if any of the above configured UEs 205 receives UE-specific RRC signaling or DCI to transmit or receive other channels or signals, then the previous common configuration for those UEs 205 receiving the UE-specific RRC signaling (or DCI) is discarded and those UEs 205 are not required to perform the corresponding measurements. In an alternate example, if any of the above configured UEs 205 receives UE-specific RRC signaling or DCI to transmit or receive other channels or signals, then the previous common configuration for those UEs 205 is ignored only on the conflicting measurement resources and those UEs 205 are required to perform the corresponding measurements only on non-conflicting measurement resources. In one example, a UE 205 may receive an indication in a group common DCI on a PDCCH indicating the conflicting measurement resource to skip from the measurements.

In one implementation of the alternate embodiment, UE 205 is semi-statically configured by the RAN node 210 via common RRC signaling with one or more semi-persistent measurement resource in terms of at least one or more of the following parameters including periodicity, time offset, QCL assumption Type-D, time symbols, frequency resources, measurement quantities. Once the UE 205 receives the common RRC configuration and receives activation via MAC CE or group common DCI, then only the receiving UE 205 is expected to perform measurements. In one implementation, the UE 205 will stop measurements once the UE 205 is indicated semi-statically by RRC or dynamic signaling via MAC CE or group-common DCI to deactivate the semi-persistent configured measurement resources.

In an alternate implementation, the UE 205 may be configured with UE-triggered reporting behavior based on a measurement quantity, such as interference level, probability of LBT failure, etc. In such implementation, the reporting configuration may have a different time-domain behavior compared to the measurement resource configuration. In one example, the measurement resource configuration may be periodic or semi-persistent, and the reporting configuration may be aperiodic, i.e., DCI triggered and/or event-triggered in the UE 205 based on a one or more events occurring. One example of an event is the measurement quantity being above a threshold, in which case a report is triggered and reported using a MAC CE on Physical Uplink Shared Channel (“PUSCH”).

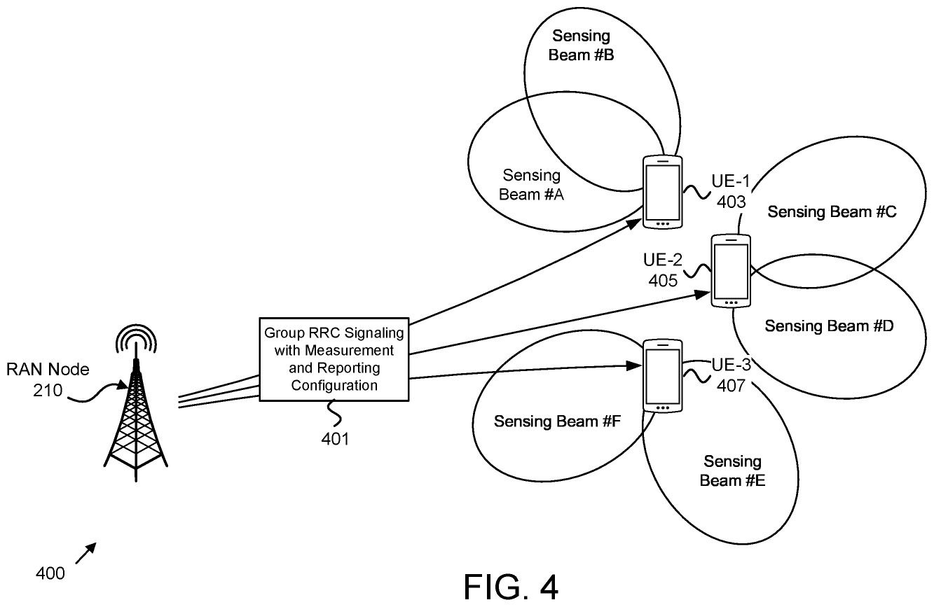

FIG. 4 illustrates an exemplary scenario 400 of combined sensing from multiple UEs in a close vicinity, according to a first solution relating to periodic/semi-persistent resource configuration for beam-specific inter-system interference measurement and/or energy detection at UE. The RAN node 210 configures multiple UEs, e.g., in close geographical proximity, to perform coordinated sensing/reporting, such that each UE performs one or more inter-system measurements according to the configuration.

In the depicted implementation, the RAN node 210 sends group RRC signaling 401 to a group of UEs, i.e., a first UE (denoted “UE-1”) 403, a second UE (denoted “UE-2”) 405, and a third UE (denoted “UE-3”) 405, where the group RRC signaling 401 contains a measurement and reporting configuration for channel access statistics. Here, the first UE 403 is indicated to perform measurements with the sensing beam #A and the sensing beam #B. Note that the sensing beam may be an Rx beam, i.e., the same beam used to receive beam transmission from the RAN node 210. Additionally, the second UE 405 is indicated to perform measurements with the sensing beam #C and the sensing beam #D, and the third UE 407 is indicated to perform measurements with the sensing beam #E and the sensing beam #F.

Each UE performs one or more inter-system measurements based on one or more of the semi-persistent and/or periodic resources configured to that UE where the UE is not expected to receive/transmit any channels and signals from any node (including gNBs, Transmit/Receive Points (“TRPs”) or other UEs) within the same network. Each UE performs measurement in specific beam direction(s) with one or more of the configured QCL assumptions Type-D or TCI states, such that the performed sensing on a predefined interval of resources from all UEs in vicinity and the combined reports at gNB cover the entire area/directions with less sensing and reporting overhead from each UE, as illustrated in FIG. 4.

According to embodiments of the second solution, a UE may be configured by the network (i.e., via RAN node) to report one or more inter-system measurements based on one or more of the semi-persistent and/or periodic measurement resources configured to (e.g., allocated or assigned to) the UE, where the UE is not expected to receive/transmit any channels and signals from any node (including gNBs, TRPs, Other UEs) within the same network. In this solution, the UE maybe configured to gather and report long-term statistics involving, for example, the number of times the measurement quantities went beyond threshold value(s) in a reporting period. Such reporting gives the network (i.e., gNB) a good indication in the long term on how the channel is getting interference from other systems/networks.

In one embodiment, the UE receives a separate RRC configuration for inter-system measurements reporting where the configuration indicates at least one or more of following including periodic and/or semi-persistent resource ID(s) for performing measurements, latest ‘N’ periodic and/or semi-persistent resources for performing measurements, reporting quantities, resources for reporting, timing property of reporting including periodic, semi-persistent or aperiodic. The UE may be triggered via MAC CE and/or DCI to semi-persistently or a-periodically report.

In one implementation, the UE is configured to report individual interference measurements on each of the occasions (on the resources configured) that could include the received power of interference and/or a single bit for each occasions, where a first bit value (e.g. “1”) corresponds to received interference power above certain (pre-) configured threshold and a second bit value (e.g. “0”) corresponds to received interference power below certain (pre-) configured threshold.

In an alternative implementation, multiple bits in a field for an occasion are employed to represent different interference power levels below or above a threshold, for example a first field value may represent an interference power level of more than 3 dB above the threshold, a second field value may represent an interference power level between 0 dB and 3 dB above the threshold, a third field value may represent an interference power level between 0 dB and 3 dB below the threshold, and a fourth field value may represent an interference power level more than 3 dB below the threshold. In another example, a reporting configuration may indicate to the UE that the combined report is to include a percentage, probability, and/or number of instances in the last N measured resources where the interference power was above a certain threshold.

In one example, when the UE is configured with multiple QCL assumption Type-D or multiple TCI states for one or more multiple measurements resources, then the UE can be configured to report the measurements for one or multiple beams in terms of number of occasions when interference strength was above a certain threshold on each of the beams. In an alternate example with multiple beams, the UE can be configured to report measurements for sub-set of best beams where the measured interference strength was lowest or, alternatively, the UE can be configured to report measurements for sub-set of worst beams where the measured interference strength was highest. In another example, averaged interference power level is reported. In another example, statistics (e.g., standard deviation, variance) of the interference power level is reported.

In alternate implementation, the reporting configuration is combined with measurement resource configuration and then it follows similar time behavior, i.e., periodic or semi-persistent or aperiodic. In other words, the reporting configuration and measurement resource configuration has the same time-domain behavior.

In alternate implementation, the reporting configuration may have a different time-domain behavior compared to the measurement resource configuration. In one example, the measurement resource configuration may be periodic or semi-persistent, and the reporting configuration may be aperiodic (i.e., DCI triggered and/or event-triggered in the UE, based on a one or more events occurring). One example of an event is the interference power level above a threshold or the number of instances in the last N measured resources where the interference power was above a certain threshold, in which case a report is triggered and reported using a MAC CE on PUSCH.

According to embodiments of the third solution, the UE is configured by network (i.e., via the RAN node) to report one or more inter-system measurements related to potential LBT success or failure based on one or more of the semi-persistent and/or periodic resources measurement configured to (e.g., assigned or allocated to) the UE, where the UE is not expected to receive/transmit any channels and signals from any node (including gNBs, TRPs, Other UEs) within the same network. In this solution, the UE may be configured to gather and report channel access statistics that are closely linked to LBT based channel access. For example, the UE may report beams where the probability of LBT success is higher. As another example the UE may report interference statistics from other networks/systems and how often the levels above thresholds are measured. Note that the UE's channel access report may include both instantaneous as well as long-term statistics.

In one implementation of the third solution, the UE receives a separate RRC configuration for inter-system measurements reporting where the configuration indicates at least one or more of following, including: periodic and/or semi-persistent resource ID(s) for performing measurements, latest ‘N’ periodic and/or semi-persistent resources for performing measurements, reporting quantities, resources for reporting, timing property of reporting including periodic, semi-persistent or aperiodic. The UE can be triggered to semi-persistently or a-periodically report via MAC CE and/or DCI.

In one embodiment of the third solution, the UE is configured to report individual interference measurements on each of the occasion (on the resources configured) that could include the LBT success/failure (e.g., energy detection on the resources configured for the occasion is below (or above) the energy detection threshold) for each occasion, where a first bit value (e.g. “1”) corresponds to LBT failure and a second bit value (e.g. “0”) corresponds to LBT success.

In an alternative, multiple bits in a field for an occasion are employed to represent different interference power levels below or above a threshold. For example, a first field value may represent an interference power level of more than 3 dB above the threshold, a second field value may represent an interference power level between 0 dB and 3 dB above the threshold, a third field value may represent an interference power level between 0 dB and 3 dB below the threshold, and a fourth field value may represent an interference power level more than 3 dB below the threshold.

In another example, a reporting configuration may indicate to the UE that the combined report is to include a percentage/probability/number of instances in the last N measured resources where the LBT was successful (or alternatively failed). In one example, when the UE is configured with multiple QCL assumption Type-D or multiple TCI states for one or more multiple measurement resources, then UE can be configured to report the LBT success or failure for one or multiple beams.

In an alternate example with multiple beams, the UE can be configured to report a sub-set of best beams where the LBT has high success rate. Alternatively, the UE may be configured to report a sub-set of worst beams where the LBT has high failure rate. In another example, averaged interference power level is reported. In another example, statistics (e.g., standard deviation, variance) of the interference power level is reported.

In an alternate implementation of the third solution, the reporting configuration is combined with measurement resource configuration and then it follows similar time behavior, i.e., periodic or semi-persistent or aperiodic, i.e., reporting configuration and measurement resource configuration has the same time-domain behavior.

In alternate implementation of the third solution, the reporting configuration may have a different time-domain behavior compared to the measurement resource configuration. In one example, the measurement resource configuration may be periodic or semi-persistent, and the reporting configuration may be aperiodic (i.e., DCI triggered and/or event-triggered in the UE, based on a one or more events occurring). One example of an event is the interference power level above a threshold or the number of LBT failure instances in the last N measured resources above a certain threshold, in which case a report is triggered and reported using a MAC CE on PUSCH.

According to embodiments of a fourth solution, the UE may be configured by network (i.e., via the RAN node) to report one or more inter-system measurements related to potential LBT success or failure based occurring for any of the physical channel transmission, where the reporting of LBT success/failure statistics can be for long-term sensing (e.g., over a past or most recent x ms/slots/measurements) or short-term sensing (e.g., time restricted measurements based on most recent measurement) performed before every transmission or a combination of thereof. In this solution, the UE's channel access report may focus especially on statistics related LBT success/failure.

In one embodiment of the fourth solution, the UE is configured to report individual interference measurements statistics that could include the LBT success/failure collected from long-term sensing or short-term sensing performed before every transmission or a combination of thereof on a configured periodic occasions, semi-persistent periodic occasions and aperiodic transmission of report whenever there is an aperiodic request triggered by DCI, RRC signaling, and/or MAC CE.

In one example, the UE may transmit separate reports for long-term sensing statistics and short-term sensing statistics on LBT success/failure. In another example, a combined reporting of long-term sensing and short-term sensing statistics based on the configured RS resource ID and any other physical channels.

In another embodiment of the fourth solution, the UE may be configured to report individual interference measurements that include the LBT success/failure as explained above, where a first bit value (e.g., “1”) corresponds to LBT failure and a second bit value (e.g., “0”) corresponds to LBT success. In an alternative, multiple bits in a field for an occasion are employed to represent different interference power levels below or above a threshold, for example a first field value may represent an interference power level of more than 3 dB above the threshold, a second field value may represent an interference power level between 0 dB and 3 dB above the threshold, a third field value may represent an interference power level between 0 dB and 3 dB below the threshold, and a fourth field value may represent an interference power level more than 3 dB below the threshold.

In another example, a reporting configuration of the UE may indicate that the combined report is to include a percentage/probability/number of instances in the last N measured resources where the LBT was successful (or alternatively failed). In one example, when the UE is configured with multiple QCL assumption Type-D or multiple TCI states for one or more multiple measurement resources, then the UE can be configured to report the LBT success or failure for one or multiple beams. In alternate example with multiple beams, the UE may be configured to report a sub-set of best beams where the LBT has high success rate. Alternatively, the UE may be configured to report a sub-set of worst beams where the LBT has high failure rate.

In some embodiments, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device antenna panel (e.g., of a UE or RAN node) may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to the RAN node. For certain condition(s), the RAN node 210 can assume the mapping between device's physical antennas to the logical entity “device panel” may not be changed. For example, the condition may include until the next update or report from device or comprise a duration of time over which the RAN node assumes there will be no change to the mapping.

A Device may report its capability with respect to the “device panel” to the RAN node or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

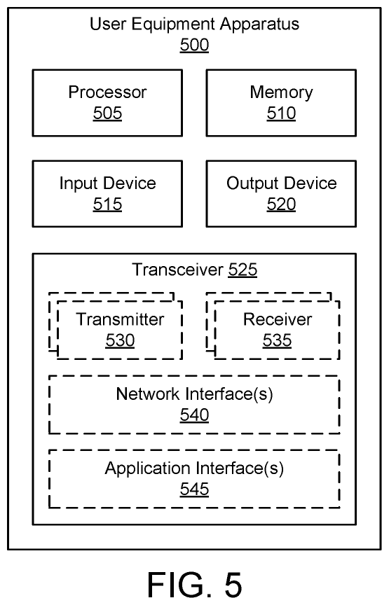

FIG. 5 depicts a user equipment apparatus 500 that may be used for measuring and reporting channel access statistics, according to embodiments of the disclosure. In various embodiments, the user equipment apparatus 500 is used to implement one or more of the solutions described above. The user equipment apparatus 500 may be one embodiment of the remote unit 105 and/or the UE 205, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panels supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user equipment apparatus 500 to implement the above described UE behaviors. In certain embodiments, the processor 505 may include an application processor (also known as “main processor”) which manages application-domain and operating system (“OS”) functions and a baseband processor (also known as “baseband radio processor”) which manages radio functions.

In various embodiments, the processor 505 receives (i.e., via the transceiver 525) a configuration message from a network, said configuration message indicating at least one measurement resource for channel sensing and a spatial beam for each indicated measurement resource. Here, the apparatus 500 does not use the measurement resource(s) (i.e., does not transmit signals on the measurement resource(s) and is not expected to receive signals on the measurement resource(s)). Additionally, the network does not use the measurement resource(s) (i.e., does not transmit signals on the measurement resource(s) and is not expected to receive signals on the measurement resource(s)). The processor 505 performs channel-sensing measurement using the indicated measurement resource(s) and each indicated spatial beam. Note that the multiple measurement resources may be configured. The processor 505 generates a channel access report using a plurality of channel-sensing measurements and the transceiver 525 sends the channel access report to the network.

In some embodiments, the configuration message further indicates a set of at least one measurement to be performed. In such embodiments, the set of at least one measurement to be performed includes at least one of: an inter-system interference measurement and an inter-network interference measurement. In some embodiments, the processor 505 determines whether a measured quantity exceeds a reporting threshold and triggers the sending of the channel access report upon determining that the measured quantity exceeds the reporting threshold.

In some embodiments, the processor 505 performs the channel-sensing measurement using the indicated measurement resource(s) by detecting an amount of energy on the indicated measurement resource(s) and comparing the detected amount against an energy detection threshold. In certain embodiments, the configuration message further includes the energy detection threshold, said threshold including at least one of: a detection threshold for inter-system interference measurement and a detection threshold for inter-network interference measurement. In certain embodiments, the channel access report indicates how often a detected amount of energy exceeded the energy detection threshold.

In some embodiments, the spatial beam for an indicated measurement resource is a spatial beam associated with a CORESET configured to (e.g., assigned to) the apparatus. In certain embodiments, an indicated measurement resource may include at least one symbol of the CORESET. In some embodiments, an indicated measurement resource may be a zero-power CSI reference signal (“ZP-CSI-RS”). In some embodiments, the measurement resource(s) includes a set of measure measurement resources over one or multiple bandwidth parts (i.e., configured DL BWP(s)) of the apparatus.

In some embodiments, the transceiver 525 further receives a resource allocation that conflicts with a configured measurement resource. In response to receiving the conflicting resource allocation the processor 505 stops performing channel-sensing measurements on the conflicted measurement resource. In such embodiments, the conflicting resource allocation may include at least one of: a downlink resource assignment and an uplink grant.

In some embodiments, the channel access report includes long-term average interference levels from the last M measurement resource periods. In certain embodiments, the channel access report includes short-term interference values for each of the last N measurement resource periods, where N<M.

In certain embodiments, the channel access report includes a rate of LBT failure and/or a probability of LBT failure. In other embodiments, the channel access report includes a rate of LBT success and/or a probability of LBT success. In certain embodiments, the processor 505 triggers the sending of the channel access report occurs in response to the probability of LBT success being less than a reporting threshold. In certain embodiments, the channel access report indicates one or more beams having a probability of LBT success above a particular threshold.

In some embodiments, receiving the configuration message includes receiving a UE-specific RRC signaling message. Here, the indicated measurement resource(s) may include at least one of: a periodic time-domain resource and a semi-static time-domain resource. In other embodiments, receiving the configuration message includes receiving common RRC signaling Here, the indicated measurement resource(s) may include at least one of: a periodic time-domain resource and a semi-static time-domain resource.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to measuring and reporting channel access statistics and/or mobile operation. For example, the memory 510 may store various parameters, panel/beam configurations, resource assignments, policies, and the like as described above. In certain embodiments, the memory 510 also stores program code and related data, such as an operating system or other controller algorithms operating on the apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

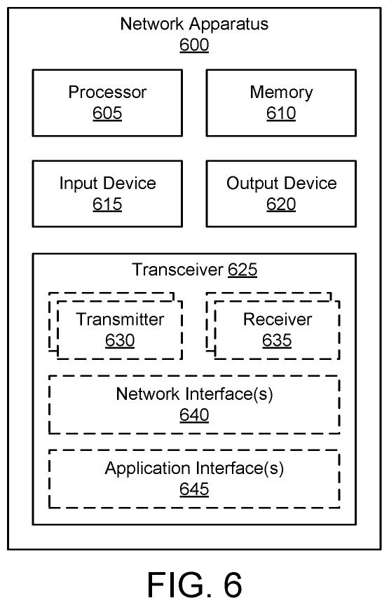

FIG. 6 depicts a network apparatus 600 that may be used for measuring and reporting channel access statistics, according to embodiments of the disclosure. In one embodiment, network apparatus 600 may be one implementation of an evaluation device, such as the base unit 121 and/or the RAN node 210, as described above. Furthermore, the base network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the network apparatus 600 is a RAN node (e.g., gNB) that communicates with one or more UEs, as described herein. In such embodiments, the processor 605 controls the network apparatus 600 to perform the above described RAN behaviors. When operating as a RAN node, the processor 605 may include an application processor (also known as “main processor”) which manages application-domain and operating system (“OS”) functions and a baseband processor (also known as “baseband radio processor”) which manages radio functions.

In various embodiments, the processor 605 selects at least one measurement resource for channel sensing and a spatial beam for each selected measurement resource. The transceiver 625 transmits a configuration message to a UE, said configuration message indicating the selected measurement resource(s) for channel sensing and the selected spatial beam(s). Here, the UE does not use the measurement resource(s) (i.e., does not transmit signals on the measurement resource(s) and is not expected to receive signals on the measurement resource(s)). Additionally, the network does not use the measurement resource(s) (i.e., does not transmit signals on the measurement resource(s) and is not expected to receive signals on the measurement resource(s)). The transceiver 625 receives a channel access report from the UE, said channel access report including channel access statistics generated using a plurality of channel-sensing measurements performed on the selected measurement resource(s) and the selected spatial beam(s).

In some embodiments, transmitting the configuration message includes transmitting to a group of UEs. In certain embodiments, the UEs in the group of UEs are in spatial proximity to each other, where each UE is configured with a UE-specific spatial beam.

In some embodiments, transmitting the configuration message includes transmitting common RRC signaling. Here, the selected measurement resource(s) may include at least one of: a periodic time-domain resource and a semi-static time-domain resource. In other embodiments, transmitting the configuration message includes transmitting a UE-specific RRC signaling message. Here, the selected measurement resource(s) may include at least one of: a periodic time-domain resource and a semi-static time-domain resource.

In some embodiments, the configuration message further indicates a set of at least one measurement to be performed. Here, the set of at least one measurement to be performed includes at least one of: an inter-system interference measurement and an inter-network interference measurement. In some embodiments, the configuration message further includes a reporting threshold, where the UE sends the channel access report in response to a measured quantity exceeding the reporting threshold.

In some embodiments, the configuration message further includes an energy detection threshold, said threshold including at least one of: a detection threshold for inter-system interference measurement and a detection threshold for inter-network interference measurement. In certain embodiments, the channel access report indicates how often a detected amount of energy exceeded the energy detection threshold.

In some embodiments, the spatial beam for a selected measurement resource is a spatial beam associated with a CORESET configured to (e.g., assigned to) the UE. In certain embodiments, an indicated measurement resource includes at least one symbol of the CORESET. In some embodiments, an indicated measurement resource may include a zero-power CSI reference signal.

In some embodiments, the transceiver further transmits a second configuration message to the UE. Here, the second configuration message indicating a set of configured bandwidth parts. In such embodiments, the measurement resource(s) includes a set of measurement resources over one or multiple bandwidth parts (i.e., configured DL BWP(s)) of the UE.

In some embodiments, the transceiver further transmits a resource allocation that conflicts with a configured measurement resource. Here, the conflicting resource allocation includes at least one of: a downlink resource assignment and an uplink grant. In such embodiments, the conflicting resource allocation indicates to the UE to stop performing channel-sensing measurement on the conflicted measurement resource.

In some embodiments, the channel access report includes long-term average interference levels from the last M measurement resource periods. In certain embodiments, the channel access report includes short-term interference values for each of the last N measurement resource periods, where N<M.

In some embodiments, the channel access report includes a rate of LBT failure and/or a probability of LBT failure. In certain embodiments, sending the channel access report occurs in response to the probability of LBT failure being greater than a reporting threshold. In other embodiments, the channel access report includes a rate of LBT success and/or a probability of LBT success. In certain embodiments, the channel access report indicates one or more beams having a probability of LBT success above a particular threshold.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to measuring and reporting channel access statistics. For example, the memory 610 may store parameters, configurations, resource assignments, policies, and the like, as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with network functions in the Public Land Mobile Network (“PLMN”) and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

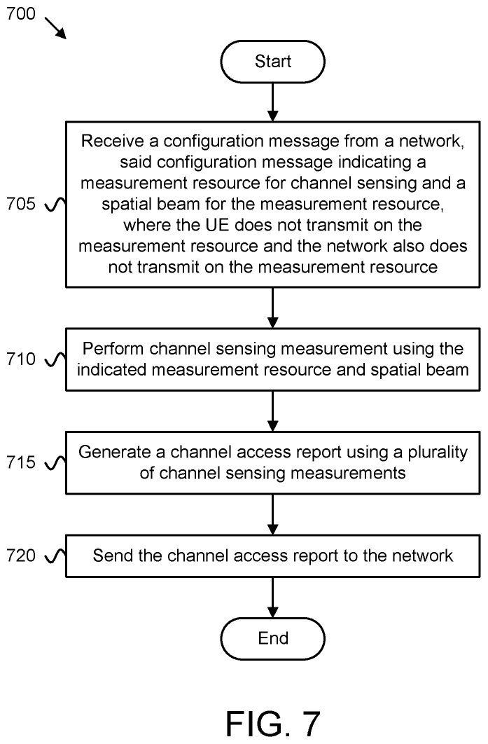

FIG. 7 depicts one embodiment of a method 700 for measuring and reporting channel access statistics, according to embodiments of the disclosure. In various embodiments, the method 700 is performed by a user equipment device, such as the remote unit 105, the UE 205, and/or the user equipment apparatus 500, as described above. In some embodiments, the method 700 is performed by a processor, such as a microcontroller, a microprocessor, a CPU, a GPU, an auxiliary processing unit, a FPGA, or the like.

The method 700 begins and receives 705 a configuration message from a network, said configuration message indicating a measurement resource for channel sensing and a spatial beam for the measurement resource. Here, the UE does not transmit on the measurement resource and the network also does not transmit on the measurement resource. The method 700 includes performing 710 channel-sensing measurement using the indicated measurement resource and spatial beam. The method 700 includes generating 715 a channel access report using a plurality of channel-sensing measurements. The method 700 includes sending 720 the channel access report to the network. The method 700 ends.

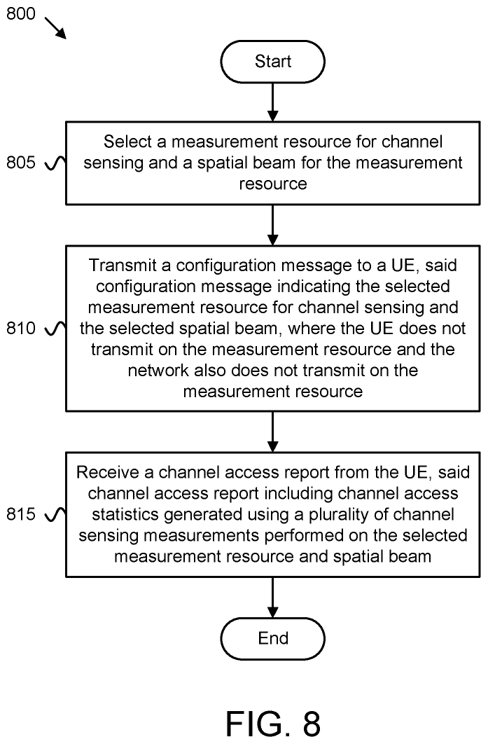

FIG. 8 depicts one embodiment of a method 800 for measuring and reporting channel access statistics, according to embodiments of the disclosure. In various embodiments, the method 800 is performed by a RAN device in a network, such as the base unit 121, the RAN node 210 and/or the network apparatus 600, as described above. In some embodiments, the method 800 is performed by a processor, such as a microcontroller, a microprocessor, a CPU, a GPU, an auxiliary processing unit, a FPGA, or the like.

The method 800 begins and selects 805 a measurement resource for channel sensing and a spatial beam for the measurement resource. The method 800 include transmitting 810 a configuration message to a UE, said configuration message indicating the selected measurement resource for channel sensing and the selected spatial beam. Here, the UE does not transmit on the measurement resource and the network also does not transmit on the measurement resource. The method 800 includes receiving 815 a channel access report from the UE, said channel access report including channel access statistics generated using a plurality of channel-sensing measurements performed on the selected measurement resource and spatial beam. The method 800 ends.

Disclosed herein is a first apparatus for measuring and reporting channel access statistics, according to embodiments of the disclosure. The first apparatus may be implemented by a UE device, such as the remote unit 105, the UE 205, and/or the user equipment apparatus 500, described above. The first apparatus includes a processor and a transceiver (i.e., implementing a radio interface) that receives a configuration message from a network, said configuration message indicating at least one measurement resource for channel sensing and a spatial beam for each measurement resource. Here, the first apparatus does not use the at least one measurement resource (i.e., does not transmit signals on the at least one measurement resource and is not expected to receive signals on the at least one measurement resource). Additionally, the network does not use the at least one measurement resource (i.e., does not transmit signals on the at least one measurement resource and is not expected to receive signals on the at least one measurement resource). The processor performs channel-sensing measurement using the indicated at least one measurement resource and each indicated spatial beam. Note that the multiple measurement resources may be configured. The processor generates a channel access report using a plurality of channel-sensing measurements and the transceiver sends the channel access report to the network.

In some embodiments, the configuration message further indicates a set of at least one measurement to be performed. In such embodiments, the set of at least one measurement to be performed includes at least one of: an inter-system interference measurement and an inter-network interference measurement. In some embodiments, sending the channel access report occurs in response to a measured quantity exceeding a reporting threshold.

In some embodiments, performing the channel-sensing measurement using the indicated at least one measurement resource includes detecting an amount of energy on the indicated at least one measurement resource and comparing the detected amount against an energy detection threshold. In certain embodiments, the configuration message further includes the energy detection threshold, said threshold including at least one of: a detection threshold for inter-system interference measurement and a detection threshold for inter-network interference measurement. In certain embodiments, the channel access report indicates how often a detected amount of energy exceeded the energy detection threshold.

In some embodiments, the spatial beam for an indicated measurement resource may be a spatial beam associated with a Control Resource Set (“CORESET”) configured to (e.g., assigned to) the apparatus. In certain embodiments, the at least one measurement resource includes at least one symbol of the CORESET. In some embodiments, the at least one measurement resource includes a zero-power CSI reference signal (“ZP-CSI-RS”). In some embodiments, the at least one measurement resource includes a set of measurement resources over one or multiple bandwidth parts (i.e., configured DL BWP(s)) of the apparatus.

In some embodiments, the transceiver further receives a resource allocation that conflicts with a configured measurement resource. In response to receiving the conflicting resource allocation the processor stops performing channel-sensing measurements on the conflicted measurement resource. In such embodiments, the conflicting resource allocation may include at least one of: a downlink resource assignment and an uplink grant.

In some embodiments, the channel access report includes long-term average interference levels from the last M periods for measurement resources. In certain embodiments, the channel access report includes short-term interference values for each of the last N periods for measurement resources, where N<M.

In certain embodiments, the channel access report includes a rate of LBT failure and/or a probability of LBT failure. In other embodiments, the channel access report includes a rate of LBT success and/or a probability of LBT success. In certain embodiments, sending the channel access report occurs in response to the probability of LBT success being less than a reporting threshold. In certain embodiments, the channel access report indicates one or more beams having a probability of LBT success above a particular threshold.

In some embodiments, receiving the configuration message includes receiving a UE-specific RRC signaling message. Here, the indicated at least one measurement resource may include at least one of: a periodic time-domain resource and a semi-static time-domain resource.

In other embodiments, receiving the configuration message includes receiving common RRC signaling. Here, the indicated at least one measurement resource may include at least one of: a periodic time-domain resource and a semi-static time-domain resource.

Disclosed herein is a first method for measuring and reporting channel access statistics, according to embodiments of the disclosure. The first method may be performed by a UE device, such as the remote unit 105, the UE 205, and/or the user equipment apparatus 500, described above. The first method includes receiving a configuration message from a network, said configuration message indicating at least one measurement resource for channel sensing and a spatial beam for each measurement resource. Here, the UE does not use the at least one measurement resource (i.e., does not transmit signals on the at least one measurement resource and is not expected to receive signals on the at least one measurement resource). Additionally, the network does not use the at least one measurement resource (i.e., does not transmit signals on the at least one measurement resource and is not expected to receive signals on the at least one measurement resource). The first method includes performing channel-sensing measurement using the indicated at least one measurement resource and each indicated spatial beam. Note that the multiple measurement resources may be configured. The first method includes generating a channel access report using a plurality of channel-sensing measurements and sending the channel access report to the network.

In some embodiments, the configuration message further indicates a set of at least one measurement to be performed. In such embodiments, the set of at least one measurement to be performed includes at least one of: an inter-system interference measurement and an inter-network interference measurement. In some embodiments, sending the channel access report occurs in response to a measured quantity exceeding a reporting threshold.

In some embodiments, performing the channel-sensing measurement using the indicated at least one measurement resource includes detecting an amount of energy on the indicated at least one measurement resource and comparing the detected amount against an energy detection threshold. In certain embodiments, the configuration message further includes the energy detection threshold, said threshold including at least one of: a detection threshold for inter-system interference measurement and a detection threshold for inter-network interference measurement. In certain embodiments, the channel access report indicates how often a detected amount of energy exceeded the energy detection threshold.

In some embodiments, the spatial beam for an indicated measurement resource may be a spatial beam associated with a CORESET configured to (e.g., assigned to) the UE device. In certain embodiments, the at least one measurement resource includes at least one symbol of the CORESET. In some embodiments, the at least one measurement resource includes a zero-power CSI reference signal (“ZP-CSI-RS”). In some embodiments, the at least one measurement resource includes a set of measurement resources over one or multiple bandwidth parts (i.e., configured DL BWP(s)) of the UE device.

In some embodiments, the first method further includes receiving a resource allocation that conflicts with a configured measurement resource and stopping the performing of channel-sensing measurements on the conflicted measurement resource in response to receiving the conflicting resource allocation. In such embodiments, the conflicting resource allocation including at least one of: a downlink resource assignment and an uplink grant.

In some embodiments, the channel access report includes long-term average interference levels from the last M measurement resource periods. In certain embodiments, the channel access report includes short-term interference values for each of the last N measurement resource periods, where N<M.

In certain embodiments, the channel access report includes a rate of LBT failure and/or a probability of LBT failure. In other embodiments, the channel access report includes a rate of LBT success and/or a probability of LBT success. In certain embodiments, sending the channel access report occurs in response to the probability of LBT success being less than a reporting threshold. In certain embodiments, the channel access report indicates one or more beams having a probability of LBT success above a particular threshold.

In some embodiments, receiving the configuration message includes receiving a UE-specific RRC signaling message. Here, the indicated at least one measurement resource may include at least one of: a periodic time-domain resource and a semi-static time-domain resource. In other embodiments, receiving the configuration message includes receiving common RRC signaling. Here, the indicated at least one measurement resource may include at least one of: a periodic time-domain resource and a semi-static time-domain resource.

Disclosed herein is a second apparatus for measuring and reporting channel access statistics, according to embodiments of the disclosure. The second apparatus may be implemented by a device in a radio access network (“RAN”), such as the base unit 121, the RAN node 210, and/or the network apparatus 600, described above. The second apparatus includes a transceiver (i.e., implementing a radio interface) and a processor that selects at least one measurement resource for channel sensing and a spatial beam for each measurement resource. The transceiver transmits a configuration message to a User Equipment (“UE”), said configuration message indicating the selected at least one measurement resource for channel sensing and each selected spatial beam. Here, the UE does not use the at least one measurement resource (i.e., does not transmit signals on the at least one measurement resource and is not expected to receive signals on the at least one measurement resource). Additionally, the network does not use the at least one measurement resource (i.e., does not transmit signals on the at least one measurement resource and is not expected to receive signals on the at least one measurement resource). The transceiver receives a channel access report from the UE, said channel access report including channel access statistics generated using a plurality of channel-sensing measurements performed on the selected at least one measurement resource and each selected spatial beam.

In some embodiments, transmitting the configuration message includes transmitting to a group of UEs. In certain embodiments, the UEs in the group of UEs are in spatial proximity to each other, where each UE is configured with a UE-specific spatial beam.

In some embodiments, transmitting the configuration message includes transmitting common RRC signaling. Here, the selected at least one measurement resource may include at least one of: a periodic time-domain resource and a semi-static time-domain resource. In other embodiments, transmitting the configuration message includes transmitting a UE-specific RRC signaling message. Here, the selected at least one measurement resource may include at least one of: a periodic time-domain resource and a semi-static time-domain resource.

In some embodiments, the configuration message further indicates a set of at least one measurement to be performed. Here, the set of at least one measurement to be performed includes at least one of: an inter-system interference measurement and an inter-network interference measurement. In some embodiments, the configuration message further includes a reporting threshold, where the UE sends the channel access report in response to a measured quantity exceeding the reporting threshold.

In some embodiments, the configuration message further includes an energy detection threshold, said threshold including at least one of: a detection threshold for inter-system interference measurement and a detection threshold for inter-network interference measurement. In certain embodiments, the channel access report indicates how often a detected amount of energy exceeded the energy detection threshold.

In some embodiments, the spatial beam for a selected measurement resource includes a spatial beam associated with a CORESET configured to (e.g., assigned to) the UE. In certain embodiments, the at least one measurement resource includes at least one symbol of the CORESET. In some embodiments, the at least one measurement resource includes a zero-power CSI reference signal.

In some embodiments, the transceiver further transmits a second configuration message to the UE. Here, the second configuration message indicating a set of configured bandwidth parts. In such embodiments, the at least one measurement resource includes a set of measurement resources over one or multiple bandwidth parts (i.e., configured DL BWP(s)) of the UE.

In some embodiments, the transceiver further transmits a resource allocation that conflicts with a configured measurement resource. Here, the conflicting resource allocation includes at least one of: a downlink resource assignment and an uplink grant. In such embodiments, the conflicting resource allocation indicates to the UE to stop performing channel-sensing measurement on the conflicted measurement resource.

In some embodiments, the channel access report includes long-term average interference levels from the last M periods for measurement resources. In certain embodiments, the channel access report includes short-term interference values for each of the last N periods for measurement resources, where N<M.

In some embodiments, the channel access report includes a rate of LBT failure and/or a probability of LBT failure. In certain embodiments, sending the channel access report occurs in response to the probability of LBT failure being greater than a reporting threshold. In other embodiments, the channel access report includes a rate of LBT success and/or a probability of LBT success. In certain embodiments, the channel access report indicates one or more beams having a probability of LBT success above a particular threshold.

Disclosed herein is a second method for measuring and reporting channel access statistics, according to embodiments of the disclosure. The second method may be performed by a device in a radio access network (“RAN”), such as the base unit 121, the RAN node 210, and/or the network apparatus 600, described above. The second method includes selecting at least one measurement resource for channel sensing and a spatial beam for each measurement resource and transmitting a configuration message to a UE, said configuration message indicating the selected at least one measurement resource for channel sensing and each selected spatial beam. Here, the UE does not use the at least one measurement resource (i.e., does not transmit signals on the at least one measurement resource and is not expected to receive signals on the at least one measurement resource). Additionally, the network does not use the at least one measurement resource (i.e., does not transmit signals on the at least one measurement resource and is not expected to receive signals on the at least one measurement resource). The second method includes receiving a channel access report from the UE, said channel access report including channel access statistics generated using a plurality of channel-sensing measurements performed on the selected at least one measurement resource and each selected spatial beam.

In some embodiments, transmitting the configuration message includes transmitting to a group of UEs. In certain embodiments, the UEs in the group of UEs are in spatial proximity to each other, where each UE is configured with a UE-specific spatial beam.

In some embodiments, transmitting the configuration message includes transmitting common RRC signaling. Here, the selected at least one measurement resource may include at least one of: a periodic time-domain resource and a semi-static time-domain resource. In other embodiments, transmitting the configuration message includes transmitting a UE-specific RRC signaling message. Here, the selected at least one measurement resource may include at least one of: a periodic time-domain resource and a semi-static time-domain resource.

In some embodiments, the configuration message further indicates a set of at least one measurement to be performed. Here, the set of at least one measurement to be performed includes at least one of: an inter-system interference measurement and an inter-network interference measurement. In some embodiments, the configuration message further includes a reporting threshold, where the UE sends the channel access report in response to a measured quantity exceeding the reporting threshold.

In some embodiments, the configuration message further includes an energy detection threshold, said threshold including at least one of: a detection threshold for inter-system interference measurement and a detection threshold for inter-network interference measurement. In certain embodiments, the channel access report indicates how often a detected amount of energy exceeded the energy detection threshold.

In some embodiments, the spatial beam for a selected measurement resource may be a spatial beam associated with a CORESET configured to (e.g., assigned to) the UE. In certain embodiments, the at least one measurement resource may include at least one symbol of the CORESET. In some embodiments, the at least one measurement resource includes a zero-power CSI reference signal.

In some embodiments, the second method further includes transmitting a second configuration message to the UE. Here, the second configuration message indicating a set of configured bandwidth parts. In such embodiments, the at least one measurement resource includes a set of measurement resources over one or multiple bandwidth parts (i.e., configured DL BWP(s)) of the UE.

In some embodiments, the second method further includes transmitting a resource allocation that conflicts with a configured measurement resource. Here, the conflicting resource allocation includes at least one of: a downlink resource assignment and an uplink grant. In such embodiments, the conflicting resource allocation indicates to the UE to stop performing channel-sensing measurement on the conflicted measurement resource.

In some embodiments, the channel access report includes long-term average interference levels from the last M measurement resource periods. In certain embodiments, the channel access report includes short-term interference values for each of the last N measurement resource periods, where N<M.

In some embodiments, the channel access report includes a rate of LBT failure and/or a probability of LBT failure. In certain embodiments, sending the channel access report occurs in response to the probability of LBT failure being greater than a reporting threshold. In other embodiments, the channel access report includes a rate of LBT success and/or a probability of LBT success. In certain embodiments, the channel access report indicates one or more beams having a probability of LBT success above a particular threshold.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. An apparatus comprising:
a processor; and
a memory coupled to the processor, the memory comprising instructions executable by the processor to cause the apparatus to:
receive, from a network entity, a message indicating a resource exclusive to perform a channel sensing measurement on and a spatial beam associated with the resource;
perform the channel sensing measurement on the resource and using the spatial beam;
generate a channel access report based on the performed channel sensing measurement; and
transmit the channel access report to the network entity.

17. The apparatus of claim 16, wherein the message further indicates a set of at least one measurement to be performed, the set of at least one measurement to be performed comprising an inter-system interference measurement or an inter-network interference measurement.

18. The apparatus of claim 16, wherein to perform the channel sensing measurement on the resource and using the spatial beam, the instructions are further executable by the processor to cause the apparatus to detect an amount of energy on the resource and compare the detected amount of energy against an energy detection threshold, wherein the message includes the energy detection threshold comprising a detection threshold for inter-system interference measurement or a detection threshold for inter-network interference measurement.

19. The apparatus of claim 16, wherein the spatial beam for the resource comprises a spatial beam associated with a Control Resource Set (“CORESET”) configured to the apparatus.

20. The apparatus of claim 16, wherein the resource comprises a zero-power channel state information (“CSI”) reference signal, wherein the apparatus does not transmit on the resource.

21. The apparatus of claim 16, wherein the resource comprises a set of measurement resources over one or more bandwidth parts configured to the apparatus.

22. The apparatus of claim 16, wherein the channel access report comprises:
long-term average interference levels from the last M periods for measurement resources, and
short-term interference values for each of the last N periods for measurement resources, where N<M.

23. The apparatus of claim 22, wherein the channel access report comprises a rate of LBT failure and/or a probability of LBT success.

24. The apparatus of claim 23, wherein the channel access report indicates one or more beams having a probability of LBT success above a particular threshold.

25. The apparatus of claim 16, wherein to receive the message, the instructions are further executable by the processor to cause the apparatus to receive a UE-specific RRC signaling message, wherein the resource comprises a periodic time-domain resource or a semi-static time-domain resource.

26. A method at a User Equipment (“UE”), the method comprising:
receiving, from a network entity, a message indicating a resource exclusive to perform a channel sensing measurement on and a spatial beam associated with the resource;
performing the channel sensing measurement on the resource and using the spatial beam;
generating a channel access report based on the performed channel sensing measurement; and
transmitting the channel access report to the network entity.

27. An apparatus in a network, the apparatus comprising:
a processor; and
a memory coupled to the processor, the memory comprising instructions executable by the processor to cause the apparatus to:
select a resource exclusive to perform a channel sensing measurement on and a spatial beam associated with the resource;
transmit, to a User Equipment (“UE”), a message indicating the resource; and
receive, from the UE, a channel access report comprising channel access statistics generated using a plurality of channel sensing measurements performed on the resource and using the spatial beam.

28. The apparatus of claim 27, wherein to transmit the message, the instructions are further executable by the processor to cause the apparatus to transmit to a group of UEs.

29. The apparatus of claim 27, wherein to transmit the message, the instructions are further executable by the processor to cause the apparatus to transmit common RRC signaling, and wherein the resource comprises a periodic time-domain resource or a semi-static time-domain resource.

30. The apparatus of claim 27, wherein to transmit the message, the instructions are further executable by the processor to cause the apparatus to transmit a UE-specific RRC signaling message, wherein the resource comprises a periodic time-domain resource or a semi-static time-domain resource.

31. The apparatus of claim 27, wherein the message further includes an energy detection threshold comprising a detection threshold for inter-system interference measurement or a detection threshold for inter-network interference measurement.

32. The apparatus of claim 27, wherein the spatial beam for the resource comprises a spatial beam associated with a Control Resource Set (“CORESET”) configured to the UE.

33. The apparatus of claim 27, wherein the resource comprises a zero-power channel state information (“CSI”) reference signal, wherein the apparatus does not transmit on the resource.

34. The apparatus of claim 27, wherein the resource comprises a set of measurement resources over one or more bandwidth parts configured to the UE.

35. The apparatus of claim 27, wherein the channel access report comprises:
long-term average interference levels from the last M periods for measurement resources, and
short-term interference values for each of the last N periods for measurement resources, where N<M.
